(19) United States
(12) Patent Application Publication
(10) Pub. No.: US 2006/0015780 A1
(43) Pub. Date: Jan. 19, 2006

(54) Specifying data timeliness requirement and trap enabling on instruction operands of a processor

(75) Inventor: Anthony S. Fong, Kowloon Tong (HK)

Correspondence Address: QUINE INTELLECTUAL PROPERTY LAW GROUP, P.C., P O BOX 458, ALAMEDA, CA, 94501, US

(73) Assignee: CITYU RESEARCH LIMITED

(21) Appl. No.: 11/172,370

(22) Filed: Jun. 29, 2005

Related U.S. Application Data
(63) Continuation-in-part of application No. 09/953,574, filed on Sep. 13, 2001, now Pat. No. 6,941,444.
Application No. 09/953,574 is a continuation of application No. 08/736,326, filed on Oct. 23, 1996, now Pat. No. 6,292,879.
(63) Continuation-in-part of application No. 10/236,015, filed on Sep. 4, 2002.
(63) Continuation-in-part of application No. 10/198,947, filed on Jul. 18, 2002.
(60) Provisional application No. 60/584,626, filed on Jun. 30, 2004.
(60) Provisional application No. 60/007,066, filed on Oct. 25, 1995.

(51) Int. Cl. G06F 11/00

(52) U.S. Cl. 714/51; 712/244

(57) ABSTRACT

A computer has its programs in instructions and operand descriptors to specify the operands of the instructions. Apparatus for specifying data timeliness requirements of individual pieces of data pointed by the instruction operands is described hereby. The data timeliness requirements range from the local memory (the memory in the computing system processing the instructions), to the need to have the most updated copy of the piece of data in a system through the network (external memory), to any copy of the piece of data from external memory in a system through network. In a computer system wherein data items (operands) are represented by operand descriptors that can comprise object numbers, addresses, data types and sizes, vector information and other relevant information concerning the operands, with two bits to identify if the timeliness requirement of data of the operand, and one-bit flag of trap enabling of the corresponding operand, to enable a trap when the operand is encountered during processing of the instruction. The trap will further divert various handlers to service the trap according to the codes or flags set in the Processor Status Register or Processor Control Register in the processor.

### CROSS REFERENCE TO RELATED APPLICATIONS

This application claims priority from provisional patent application 60/584,626, filed 30 Jun. 2004 and incorporated herein by reference.

This application is a continuation-in-part of patent application Ser. No. 09/953,574, filed 13 Sep. 2001 (QIPLG Attorney Docket No.: 513.000111US, A. Fong, “Specifying access control and caching on operands”,), which is a continuation of patent application Ser. No. 08/736,326 filed 23 Oct. 1996, now U.S. Pat. No. 6,292,879 and which claims benefit of priority from provisional application No. 60/007,066, filed 25 Oct. 1995. Each of these applications and there referenced documents is incorporated herein by reference.

This application is further a continuation-in-part of U.S. patent application Ser. No. 10/236,015 filed 4 Sept 2002, P. L. Mok, A. Fong, “Secure Control Transfer in an Information System”,

This application is further a continuation-in-part of U.S. patent application Ser. No. 10/198,947 filed 18 Jul. 2002, Richard C. L. Li, A. Fong, “Method and Apparatus of Storage Allocation/De-allocation in Object-Oriented Programming Environment”.

### COPYRIGHT NOTICE

Pursuant to 37 C.F.R. 1.71(e), Applicant notes that a portion of this disclosure contains material that is subject to and for which is claimed copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records. All other rights are reserved, and all other reproduction, distribution, creation of derivative works based on the contents, public display, and public performance of the application or any part thereof are prohibited by applicable copyright law.

### BACKGROUND OF THE INVENTION

1. Field of the Invention

The present invention is related to digital processing systems, more specifically, concerning specifying data timeliness requirement of a piece of data pointed by an operand descriptor, from the local storage of the system processing the instruction which contains the operand, to the copies of the data residing in one or more different storage elements in one or more digital data processing systems besides the system processing the instruction, connected through networking (external storages), the most updated and not the most updated copies of the piece of data. The invention also provide the enabling of trap when encountered the individual instruction operand of an instruction if the trap enabling flag is set.

2. Description of the Prior Art

A digital data processing system (computer) instruction is composed of an opcode and one or more operands. The operands are data in either registers or memory/storage. There are no qualifiers that explicitly specify the nature and system attributes for the data except those implied by the opcode. In a descriptor architecture computer, the operands in an instruction are specified by descriptors. A descriptor of an operand usually consists of an address of the memory space of the operand, its data type and size, and vector specification if so specified.

In computing, sometimes there are requests for pieces of data that are not residing in the local storage of the processing system, which we will call external data. Since the external pieces of data may reside in various systems through networking as multiple copies, and these copies may not be consistent since some of them are more updated than others.

Because these external copies may reside in various systems through networking, the time and computing resources needed to access them may vary in a wide range. Depending on the timeliness requirements of the pieces of data, it is desirable to request for these pieces of data with the least time and/or the least amount of resource requirements that the timeliness requirements allow, so that the processing of the process will be conduct in an efficient and effective way.

To optimize the memory data access performance, it is desirable when accessing external memory data to be able to specify if the piece of data of an operand demands the most updated copy of the data or not, because the data may exist in different processing systems with different values, modified or written at different time by different programs, accessible through networking, so that an efficient way is to access a copy of this piece of data with minimum resource and time, just enough to meet its timeliness requirement. Such data timeliness requirement on individual operand will be processed through software and data will be apprehended from an appropriate system in the network.

The present computers do not have any hardware assist features to facilitate the processing of the timeliness requirements for the pieces of data, but instead, the requirements are handled in routines in software applications.

As computing systems and applications become ever more complex and diversifying, it is more and more difficult to engineer the system, measure their performance and effectiveness, and to debug the applications. Traces of execution of a part of a process, traps on memory references, and single-steps and breakpoints on a process execution, are often needed to facilitate these activities.

At present, the capability of conducting these activities is usually enabled in a number of bits as flags and codes in Processor Status Register or Processor Control Register, in a processor or through special programs.

To service single-steps, the processor will be trapped each time when an instruction finishes execution. The control flow will then be passed to a software handler. The handler will do the required work, and then pass the control flow back to where it left off.

Breakpoints are serviced in similar way as single-steps, except that in the software trap handler, the address of the instruction to be executed is compared with the entries of a breakpoint address table. If matched, the same actions will be taken as in single-steps.

For tracing memory operations, if the memory trap enable is on and there is memory operation, interruption of the processing will occur similarly as in single-step, and processing control will flow to the handler which will perform the tracing by compiling the memory address of the memory operation to a memory trace file.

For trapping memory operations, if the memory trap enable is on and there is memory operation, interruption of the processing will occur as in single-step, and processing control will flow to the handler which will compare the memory address of the memory operation with the entries of the memory address table. If matched, the control flow will be passed to a software handler, similar to the case of single-steps. Upon finishing the execution of the trap handler, the control will flow back to the process where it left off.

### SUMMARY OF THE INVENTION

The invention disclosed herein concerns features that add to the existing processors, described in the previous section of “Description of the Prior Art”. These features are parts of the computer system HISC: A High-level Instruction Set Computer.

The first feature is the data timeliness requirement residing in the operand descriptor that indicates the timeliness requirement of the piece of data pointed by the operand descriptor. The requirement is a multiple-bit code. For the first design, there are two bits for the timeliness requirement code to indicate the levels of the timeliness required, with code zero to be the local copy residing in the system which is processing the instruction that contains the operand, code one to be the most updated from an external system through network, and code two to be “no timeliness requirement”, i.e. any copy of the data is fine. Code three is reserved for future use. Refer to FIG. 2-Operand Descriptor. The size of the two-bit code may be extended, so that more sophisticated and timeliness classes can be specified.

The second feature is the trap enablingflag residing in the operand descriptor that indicates if the operand descriptor is encountered, a trap on the operand will be initiated. There are control flags in Processor Status Register, or Processor Control Register, to specify which traps of single-steps, breakpoints, tracing, and memory operation traps will be enabled. When the trap enabling flag in an operand descriptor is on and the descriptor is encountered when executing the instruction pointing to such operand descriptor, to be named operand descriptor trap, interruptions of the processing will occur, and processing control will flow to the appropriate trap handler of the highest priority. The trap handler is usually a software process. In general, operand descriptor traps have lower priority than the other traps and interrupts. They will be activated when there is no event-driven interrupt of higher interrupt priorities.

If the operand descriptor trap occurs, there is hardware logic designed to service the trap, with software support in some cases, depending on the implementation of the computing system.

With hardware logic to handle the statistics and tracing, the processor is able to continue process the process without interventions, and statistics will not have loss of time due to the software handling of the interrupt.

### BRIEF DESCRIPTION OF THE DRAWINGS

FIG. 1 is a diagram of the instruction format of the present invention.

FIG. 2 is a diagram of the operand descriptor format of the present invention.

FIG. 3 is a diagram illustrating a method for specifying operand descriptors according to specific embodiments of the present invention, data timeliness requirement of the data pointed by the operand descriptor.

FIG. 4 is a diagram illustrating a method for specifying operand descriptors according to a first alternative embodiment of the present invention, data timeliness requirement of the data pointed by the operand descriptor.

FIG. 5 is a diagram illustrating a method for specifying operand descriptors according to a specific embodiments of the present invention, trap enabling flag of the operand descriptor.

FIG. 6 is a block diagram showing a representative example logic device in which various aspects of the present invention may be embodied.

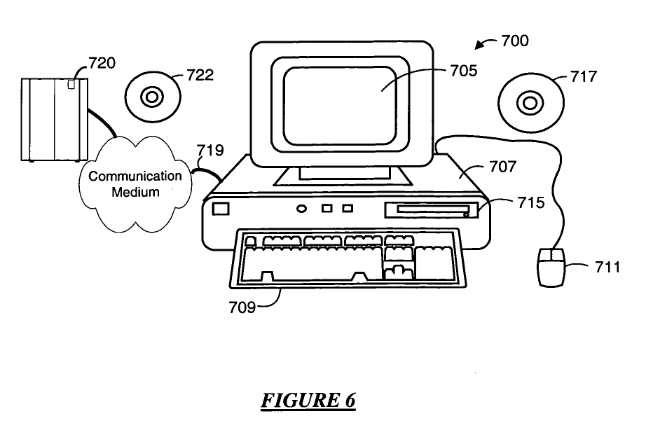

### DESCRIPTION OF A PREFERRED EMBODIMENT

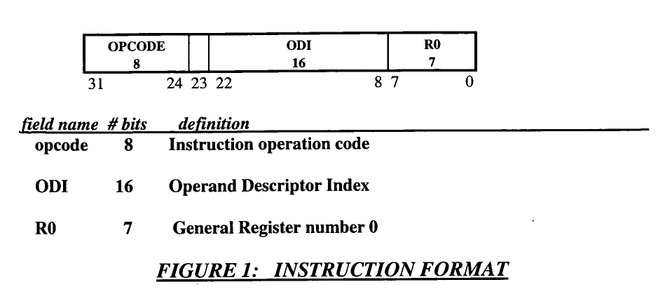

The following description presents the structure and operation of a computer system incorporating a presently preferred embodiment of the present invention. HISC is a descriptor architecture computer. An instruction with reference to memory data consists of an opcode, an index of the destination operand descriptor, and a general register number, as shown in FIG. 1. For example, to execute an LOAD instruction, the piece of data addressed by the source operand descriptor pointed by the operand descriptor index is loaded to a general register, indexed by the field GRO.

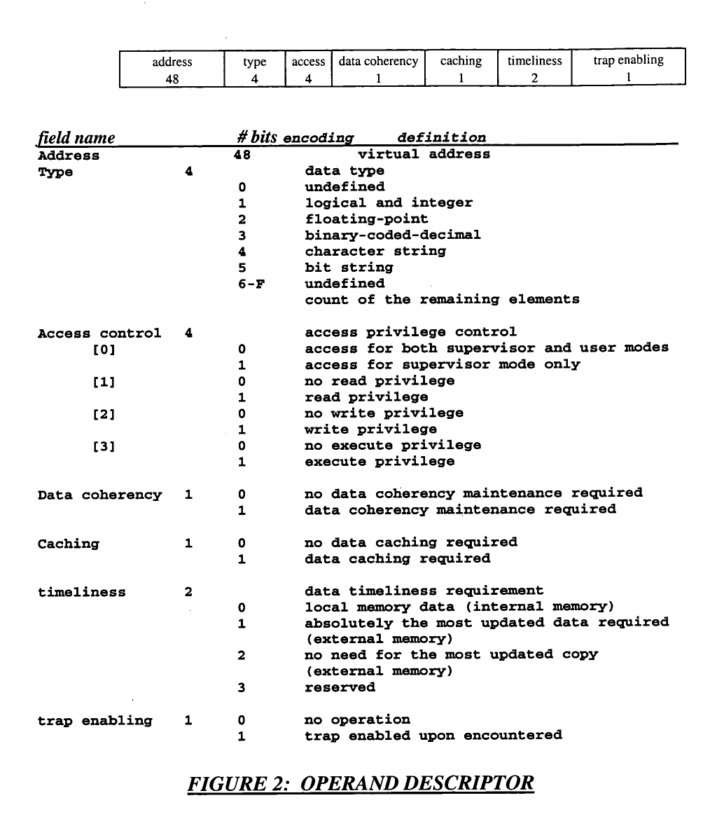

A descriptor of an operand usually consists of a virtual address of the memory space of the operand, its data type and size, and vector specification if so exists. In this invention, HISC extends the operand descriptor to include system attributes: to specify the timeliness requirement of the data of the operand, and the trap enabling flag of the operand, as shown in FIG. 2.

### A. Timeliness Requirement of the Operand Data

When a program is compiled, the object code of HISC includes three parts: the instructions, a table of operand descriptors, and the data pointed by the operand descriptors. The operand descriptors are a linear array, indexed by the operand descriptor indexes in the instructions. When the object code is initially loaded into the HISC system, the operating system will obtain the system attributes including the timeliness requirements and interrupt enabling flags of individual operands in the object code, with respective templates of the corresponding files, to pass the information to hardware logic and system programs appropriately.

Before an instruction is allowed to execute, its operand descriptors must be loaded into a special fast storage with speed comparable to a data cache, which is named operand descriptor cache. When the program is being executed, any time a memory reference is made on an operand, the data timeliness requirement in the corresponding operand descriptor cache will be checked against the memory operation and direct the processor to locate the memory data.

If the data timeliness requirement code is zero, which is the normal case and indicates the data is in the local memory or storage, the processor will request for the data from the local memory/storage, same as in the existing computing systems.

If the data timeliness requirement code is other than zero, then the request is for external memory/storage data in a system through the computing network, and control flow will go to a software handler to search for the piece of data from the network.

If the data timeliness requirement code is one, which means that the software handler must get the piece of data from a system on the computing network which is guaranteed or certified to be the most updated. There is a list of network addresses together with the corresponding memory addresses for the piece of data in the individual systems in the network that their copies of the data are guaranteed to be the most updated.

If the data timeliness requirement code is one, and there does not exist such list of network addresses together with the corresponding memory addresses for the piece of data in the individual systems in the network, or such network addresses or their corresponding memory addresses fail to point to the copy or copies of the piece of data, then a data timeliness requirement exception occurs, and control flow will be directed to the operating system for the exception handling. The process will be terminated after the operating system registers the exception, and process the termination of the process with such exception.

If the data timeliness requirement code is two, which means that the software handler will get the piece of data from any system on the network that contain the data, which does not need to be the most updated. Any route to obtain the piece of data will fulfill the request for the piece of data, and it is not necessary to have a table of valid pointers to the piece of data if there is a predefined mechanism in the system to send such request to the network.

For the timeliness requirement code two, there may or may not be a list of network addresses together with the corresponding memory/storage addresses for the piece of data in the individual systems in the network, since any copy of the piece of data will fulfill the request for the piece of data.

The data timeliness requirement code three is reserved for future use. The software handler will signal an exception to the operating system.

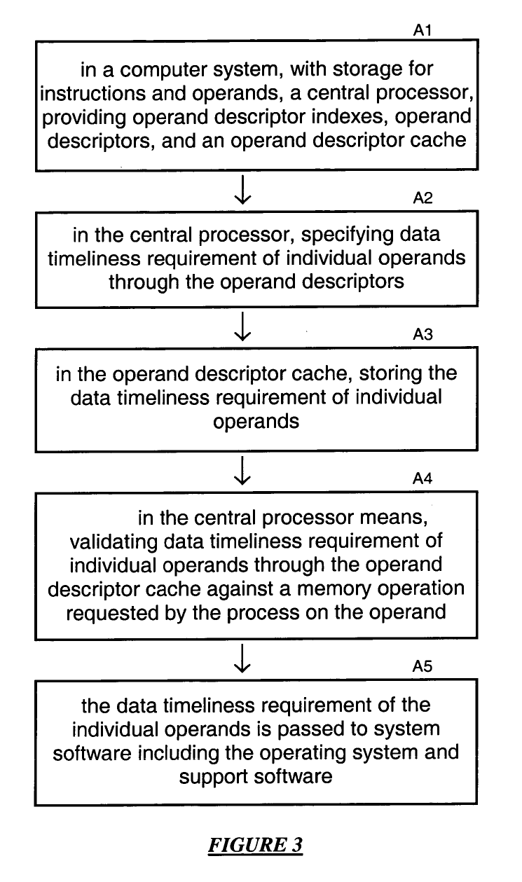

FIG. 3 illustrates a method for checking data timeliness requirement code using operand descriptors.

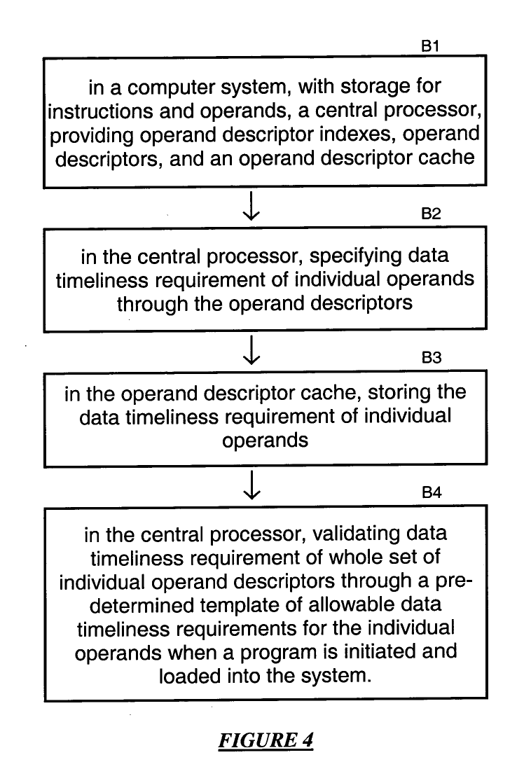

FIG. 4 illustrates a method for checking data timeliness requirement code using operand descriptors according to specific embodiments of the present invention.

### B. Trap Enabling Flag of Operand

The operand descriptor cache contains trap enabling flag on instruction operands among other system attribute codes and flags. Each time a reference is made on an instruction operand during execution of the instruction, if the trap enabling flag is on, the control flow will transfer to a trap handler.

The trap handler will decode and analyze if necessary the flags and codes in the Processor Status Register or Processor Control Register, to determine the type of trap handlers needed to execute, such as READ, WRITE, EXECUTE operations for the corresponding operands, together with tracing, statistics updates (to increment the READ, WRITE, EXECUTE operation counts in the corresponding counters in the processor). These counters may be registers and handled by hardware logic, or memory/storage locations and handled by software.

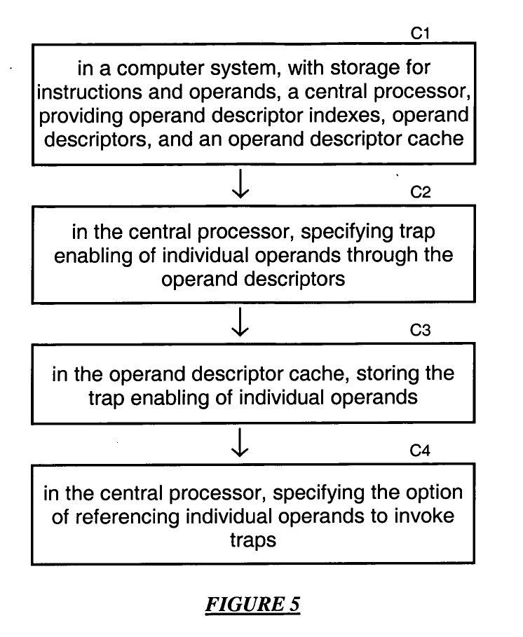

FIG. 5 illustrates a method for the trap enabling of operands using operand descriptors and further including an indication of whether operand data should be cached according to specific embodiments of the present invention.

What is claimed:

1. In a computer system, including memory for storing instructions and operands, a central processor able to fetch and decode instructions, operand descriptor indexes, operand descriptors, and memory for storing an operand descriptors, a method for specifying data timeliness requirements on individual operands comprising:
in the central processor, specifying the data timeliness requirements of individual operands using said operand descriptors;
wherein said specifying is performed by setting or resetting the data timeliness requirement in an individual operand's respective operand descriptor;

2. The method of claim 1 further comprising:
in the central processor, validating the data timeliness requirements of individual operands stored in said memory for storing operand descriptors against a memory operation requested by a process on the operand, and if said validating fails or if the required network-memory addresses for the data are not available, it will issue an exception to the operating system which will terminate said process;

3. The method of claim 1 further comprising:
in the central processor, the data timeliness requirements of individual operands stored in said memory for storing operand descriptors against a memory operation requested by a process on the operand, and the data timeliness requirements of individual operands are represented by two-bit codes, with individual unique codes to represent
a. data is to be in the local memory of the system processing the process;
b. data is to be from the external memory (memory of a system through networking of systems excluding the system that is processing the process, and the most updated copy is required;
c. data is to be from the external memory (memory of a system through networking of systems excluding the system that is processing the process, and the most updated copy is not required; and

4. The method of claim 1 further comprising:
in the central processor, the data timeliness requirements of individual operands stored in said memory for storing operand descriptors against a memory operation requested by a process on the operand, and the data timeliness requirements of individual operands are represented by two-bit codes, with individual unique codes to represent that the piece of data is to be from external memory, and the most dated copy is required, in that case, a table consisting of entries of network-memory addresses is required;

5. The method of claim 1 further comprising:
in the central processor, the data timeliness requirements of individual operands stored in said memory for storing operand descriptors against a memory operation requested by a process on the operand, and the data timeliness requirements of individual operands are represented by two-bit codes, with individual unique codes to represent that the piece of data is to be from external memory, and the most dated copy is required, in that case, a table consisting of entries of network-memory addresses is required, and if in a case of external memory such table is not available or invalid, an exception occurs, the process will be terminated and control flow will be passed to the operating system.

6. The method of claim 1 further comprising:
in the operand descriptor memory, storing the data timeliness requirements of individual operands through the operand descriptors.

7. The method of claim 1 further comprising:
in the central processor, validating the data timeliness requirements of a set of individual operand descriptors through a pre-determined allowable addresses for the individual operands established when a program is initiated.

8. In a computer system, including memory for storing instructions and operands, a central processor able to fetch and decode instructions, operand descriptor indexes, operand descriptors, and memory for storing an operand descriptors, a method for specifying the trap enabling on individual operands comprising:
in the central processor, specifying the trap enabling of individual operands using said operand descriptors;
wherein said specifying is performed by setting or resetting the trap enabling in an individual operand's respective operand descriptor;

9. The method of claim 8 further comprising:
in the operand cache, if the trap enabling is set, a trap will occur when the operand is encountered during processing of the instruction that contains the operand, and the control flow will be passed to a trap handler;

10. The method of claim 8 further comprising:
in the operand cache, if the trap enabling is set, a trap will occur when the operand is encountered during processing of the instruction that contains the operand, and the control flow will be passed to a trap handler, where control codes flags in the Processor Status Register or Processor Control Register will be examined, and control flow will be passed to individual sub-trap handlers which consist of single-steps, breakpoints, tracing on instruction addresses of a process being processed, trapping on requests of READ, WRITE, and EXECUTE memory operations, where EXECUTE is the fetching of instruction to be executed;

11. The method of claim 8 further comprising:
in the operand cache, if the trap enabling is set, a trap will occur when the operand is encountered during processing of the instruction that contains the operand, and the control flow will be passed to a trap handler, where control codes flags in the Processor Status Register or Processor Control Register will be examined, and control flow will be passed to individual sub-trap handlers which consist of single-steps, breakpoints, tracing on instruction addresses of a process being processed, trapping on requests of READ, WRITE, and EXECUTE memory operations, where EXECUTE is the fetching of instruction to be executed, for the corresponding operands, together with tracing, statistics updates (to increment the READ, WRITE, EXECUTE operation counts in the corresponding counters). These counters may be registers and handled by hardware logic, or memory locations and handled by software;

12. The method of claim 1 wherein said computer system is a high-level instruction set computer system.

13. The method of claim 1 wherein said data timeliness requirement is specified and to be complied for an individual operand for the local memory/storage in the system which is processing the instruction containing the operand.

14. The method of claim 1 wherein said data timeliness requirement is specified and to be complied for an individual operand for external memory/storage in a system on the network which is not the system processing the instruction containing the operand, according to the data timeliness requirement of the operand descriptor to be the most updated or not.

15. The method of claim 1 wherein said data timeliness requirement is specified and to be complied for an individual operand for external memory/storage in a system on the network which is not the system processing the instruction containing the operand, with the data timeliness of to be the most updated. The network-memory addresses are needed to locate such copies of the data.

16. The method of claim 1 wherein said data timeliness requirement is specified and to be complied for an individual operand for external memory/storage in a system on the network which is not the system processing the instruction containing the operand, with the data timeliness of to be the most updated. The network-memory/storage addresses are needed to locate such copies of the data, but they are either unavailable or invalid. In these cases, an exception is activated, control flow will be passed to the operating system and the process will be terminated.
